(19) United States
(12) Patent Application Publication
(10) Pub. No.: US 2012/0118826 A1
(43) Pub. Date: May 17, 2012

(54) DESALINATION SYSTEM

(75) Inventors: Boris Liberman, Even Yehuda (IL); Yosef Pinhas, Hadera (IL)

(73) Assignee: I.D.E. TECHNOLOGIES LTD., Kadima, NA (IL)

(21) Appl. No.: 13/382,936

(22) PCT Filed: Jul. 2, 2010
(86) PCT No.: PCT/IB10/53048

§ 371 Date: Jan. 9, 2012

Related U.S. Application Data
(60) Provisional application No. 61/224,082, filed on Jul. 9, 2009.

(51) Int. Cl. C02F 1/44; B01D 61/06; B01D 61/08

(52) U.S. Cl. 210/648; 210/195.2

(57) ABSTRACT

A desalination system based on forward osmosis, that uses a draw solution at high osmotic and gauge pressures to generate mechanical power from the expansion of the draw solution due to water extracted from feed water through a semi-permeable membrane. The extracted water is produced during the regeneration of the draw solution. The generated power may be used to desalinate additional feed water, e.g. via reverse osmosis, such that most power needed for the reverse osmosis is supplied from the expanding draw solution, e.g. via a work exchanger. After power recovery, partly dilute draw solution may be used to extract additional water from feed water via an additional forward osmosis module.

### CROSS REFERENCE TO RELATED APPLICATIONS

This application claims the benefit of U.S. Provisional Patent Application 61/224,082 filed on Jul. 9, 2009, which is incorporated herein by reference.

### BACKGROUND

1. Technical Field

The present invention relates to the field of desalination, and more particularly, to forward osmosis.

2. Discussion of Related Art

Desalination by osmosis is carried out according to two main principles: reverse osmosis—extracting water through a semi-permeable membrane from feed water by applying on the feed water a gauge pressure that is higher than the osmotic pressure of the feed water; and forward osmosis—drawing water through a semi-permeable membrane from feed water by a draw solution having a higher osmotic pressure than the feed water.

Forward osmosis has been implemented using a draw solution of a very high osmotic pressure (e.g. NH₃—CO₂ in water) to draw water from sea water. Forward osmosis has also been implemented to utilize the expanding draw solution to generate power, such as by contacting sea water and river water through a semi-permeable membrane, and allowing the expanding sea water to move a turbine.

### BRIEF SUMMARY

Embodiments of the present invention provide a desalination system comprising: a forward osmosis (FO) unit, arranged to expand draw solution under high gauge (G-) and high osmotic (O-) pressures with water drawn from the feed water through a semi-permeable membrane, to yield an increase in a throughput and a decrease in the osmotic pressure of the draw solution; a gauge pressure generating module arranged to introduce draw solution of high osmotic pressure into the FO unit at a high gauge pressure; a power producing work exchanger arranged to receive the expanded draw solution from the FO unit and to generate mechanical power from the expansion of the draw solution against the high gauge pressure, to yield G-de-pressurized draw solution; and an extraction module arranged to receive G-de-pressurized draw solution of decreased osmotic pressure and to the extract product water therefrom to re-concentrate the draw solution, wherein the desalination system is arranged to simultaneously produce product water and mechanical power from forward osmosis at high osmotic and high gauge pressures.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a schematic block diagram illustrating a forward osmosis (FO) unit, according to some embodiments of the invention;

FIG. 2 is a schematic block diagram illustrating a desalination system, according to some embodiments of the invention;

FIGS. 3A and 3B illustrate details of the desalination system, according to some embodiments of the invention;

FIG. 4 illustrates a numerical example for pressures involved in the operation of the FO unit, according to some embodiments of the invention; and

FIGS. 5A and 5B are schematic flowcharts illustrating a method of desalination and power recovery, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For a better understanding of the invention, the usages of the following terms in the present disclosure are defined in a non-limiting manner:

The term “gauge (G-) pressure” as used herein in this application, is defined as an applied mechanical pressure in respect to atmospheric pressure.

The term “osmotic (O-) pressure” as used herein in this application, is defined as the pressure that must be applied on a solution to prevent solvent from moving through a semi-permeable membrane into the solution, due to solute that is impermeable through the membrane.

The term “feed water” as used herein in this application, is defined as saline water that is fed into a desalination system, such as sea water.

The term “draw solution” as used herein in this application, is defined as a solution of a high osmotic pressure used to draw water through a semi-permeable membrane from feed water.

The term “forward osmosis” as used herein in this application, is defined as a process of drawing water through a semi-permeable membrane from feed water by a draw solution having a higher osmotic pressure.

The term “reverse osmosis” as used herein in this application, is defined as a process of extracting water through a semi-permeable membrane from feed water by applying on the feed water a gauge pressure that is higher than the osmotic pressure of the feed water.

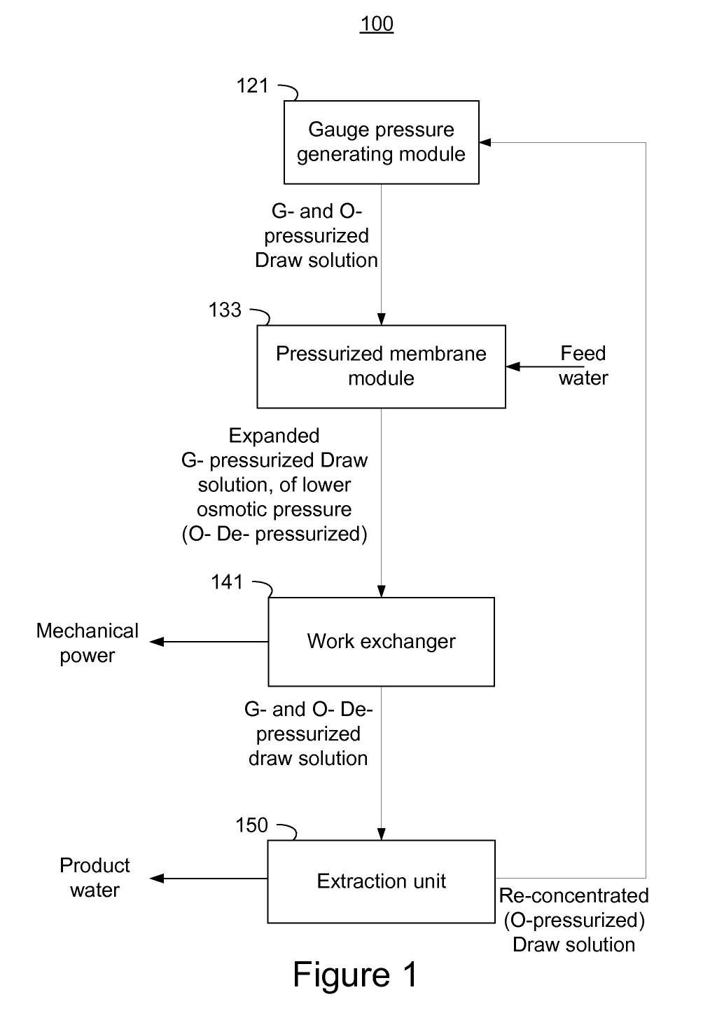

FIG. 1 is a schematic block diagram illustrating a forward osmosis (FO) unit 100, according to some embodiments of the invention. FO unit 100 operates with a draw solution of a high osmotic pressure (also termed —Intermediate High Osmotic Pressure Solution—IHOPS), for example, a solution of NH₃ and CO₂ in water which may reach osmotic pressures of 200-300 bar. FO unit 100 comprises a gauge pressure generating module 121, a pressurized membrane module 133, a work exchanger 141 and an extraction module 150.

Gauge pressure generating module 121 is arranged to introduce the draw solution (at high osmotic pressure, or O-pressurized) into pressurized membrane module 133 at a high gauge pressure (G-pressurized), which may reach 70-150 bars. The high gauge pressure balances the high osmotic pressure of the draw solution to allow the operation of the membrane in pressurized membrane module 133. Furthermore, the expansion of the (G- and O-pressurized) draw solution against the high gauge pressure allows utilizing the expansion to generate power by work exchanger 141 (see below).

Pressurized membrane module 133 is arranged to utilize the draw solution of high osmotic pressure (and high gauge pressure) to draw water from feed water through a membrane, to yield expanded draw solution of low osmotic pressure. The osmotic pressure decreases due to the addition of drawn water. The addition of drawn water expands the volume and increases the throughput of the draw solution.

Work exchanger 141 is arranged to generate mechanical power from the expansion of the draw solution against the high gauge pressure, e.g. by means of a piston pushed by the draw solution. Leaving work exchanger 141 the draw solution is at low gauge and low osmotic pressures (G- and O-depressurized).

Extraction module 150 is arranged to extract product water from the draw solution of low osmotic pressure to re-concentrate the draw solution to the original high osmotic pressure.

In this constellation, by using the G- and O-pressurized draw solution, FO unit 100 utilizes the forward osmosis process to simultaneously produce product water and energy.

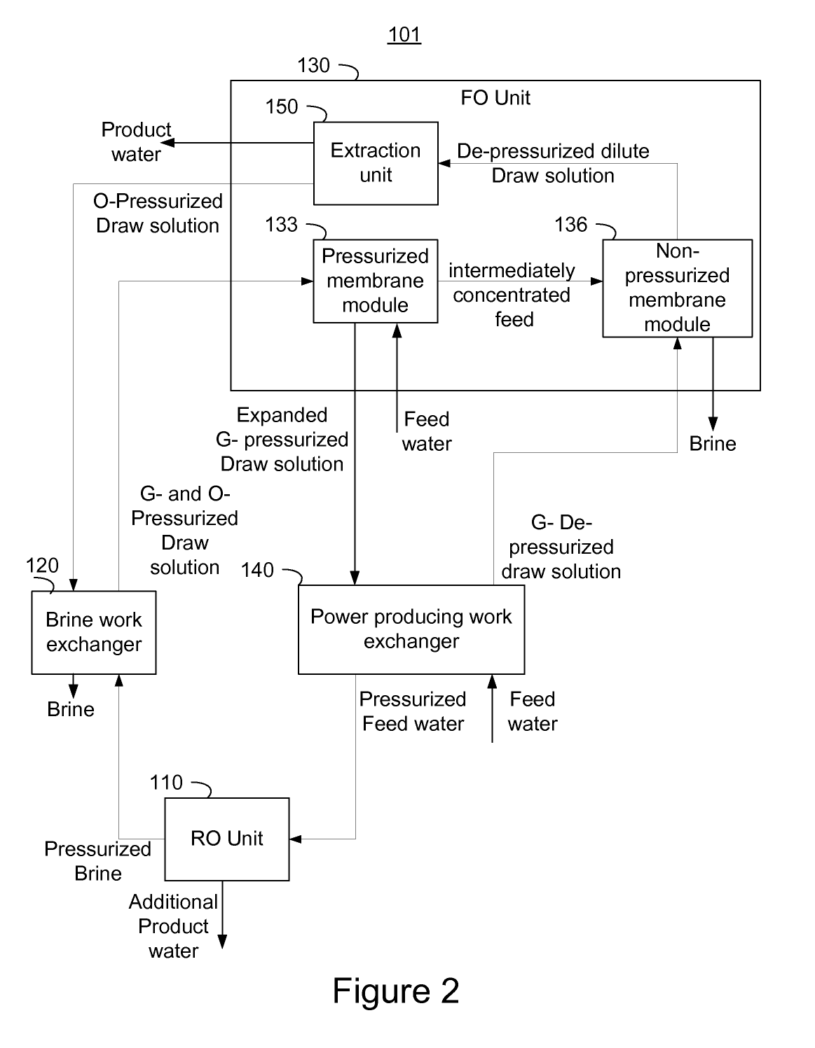

FIG. 2 is a schematic block diagram illustrating a desalination system 101, according to some embodiments of the invention. Desalination system 101 comprises an embodiment of a forward osmosis (FO) unit 130 connected via a brine work exchanger 120 and a power producing work exchanger 140 to a reverse osmosis (RO) unit 110. FO unit 130 is arranged to expand draw solution under high gauge (G-) and osmotic (O-) pressure with water drawn from feed water through a forward osmosis membrane, to yield an increase in a throughput of the pressurized draw fluid. The high gauge pressure balances the high osmotic pressure of the draw solution to allow the operation of the membrane.

FO unit 130 may comprise a pressurized FO module 133 and a non-pressurized FO module 136.

Pressurized FO module 133 utilizes the G- and O-pressurized draw solution to draw water from the feed water through a membrane, to yield expanded G-pressurized draw solution of lower osmotic pressure. The osmotic pressure decreases due to the addition of drawn water. The addition of drawn water expands the volume and increases the throughput of the G-pressurized draw solution. The feed water leaves the membrane of pressurized FO module 133 as an intermediately concentrated feed.

Non-pressurized FO module 136 utilizes G-de-pressurized draw solution (coming from power producing work exchanger 140, see below) to draw additional water from the intermediately concentrated feed to produce the G- and O-de-pressurized draw solution, which is a dilute draw solution.

FO unit 130 further comprises an extraction unit 150 arranged to draw product water from the G- and O-de-pressurized draw solution, and re-concentrate the draw solution.

RO unit 110 is arranged to receive feed water which are gauge pressurized by power producing work exchanger 140 utilizing the expansion of the G- and O-pressurized draw solution (see below). RO unit 110 is arranged to produce product water and pressurized brine from the pressurized feed water through a regular reverse osmosis process.

Power producing work exchanger 140 connects FO unit 130 to RO unit 110 and is arranged to receive the G-pressurized draw solution from FO unit 130 and to utilize the increased throughput (through expansion) of the G-pressurized draw solution to drive feed water to RO unit 110, thereby G-de-pressurizing the G-pressurized draw fluid. Power producing work exchanger 140 is thus an embodiment of work exchanger 141, in which the expansion power is utilized directly to G-pressurize feed water to RO unit 110.

Brine work exchanger 120 connects RO unit 110 to FO unit 110, and is arranged to receive the G-pressurized brine from RO unit 110 and drive the O-pressurized draw solution to FO unit 130 as G- and O-pressurized draw solution. The de-pressurized brine is removed from desalination system 101. Brine work exchanger 120 receives the regenerated O-pressurized draw solution from extraction unit 150.

Substantially all feed water throughput to RO unit 110 is supplied by power producing work exchanger 140 utilizing the increase in throughput of the expanded G-pressurized draw solution. In this constellation, by using the G- and O-pressurized draw solution, FO unit 100 utilizes the forward osmosis process to simultaneously produce product water and energy that is directly utilized to produce additional product water at a low energetic cost through RO unit 110.

In embodiments, the throughput of the pressurized brine may be about a half of the throughput of the feed water to RO unit 110, and pressurized FO module 133 may double the throughput of the G-pressurized draw solution.

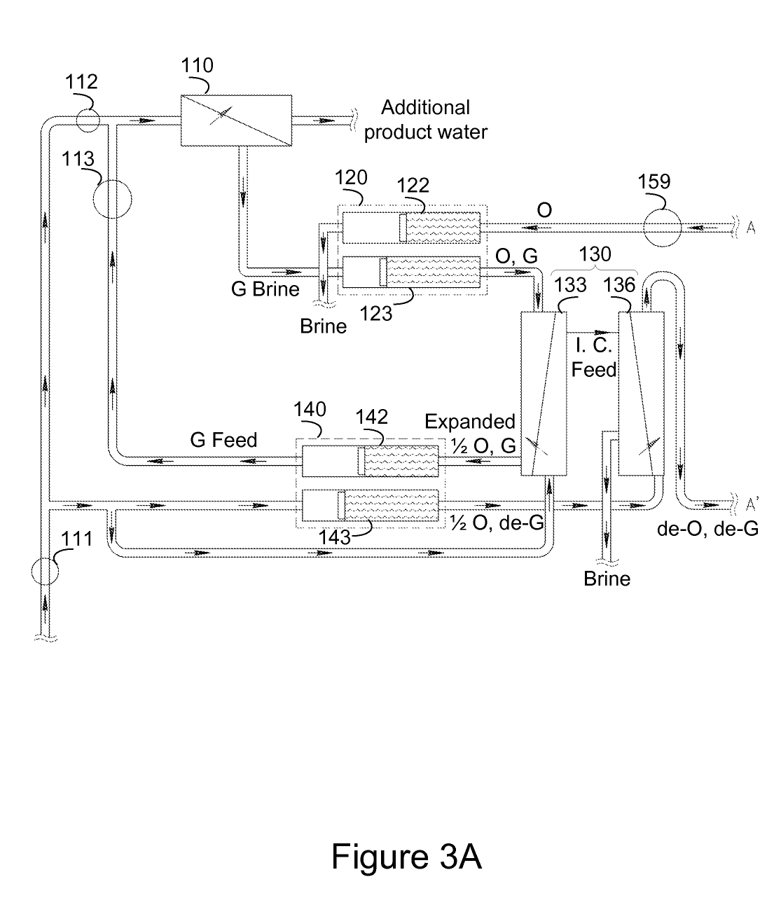

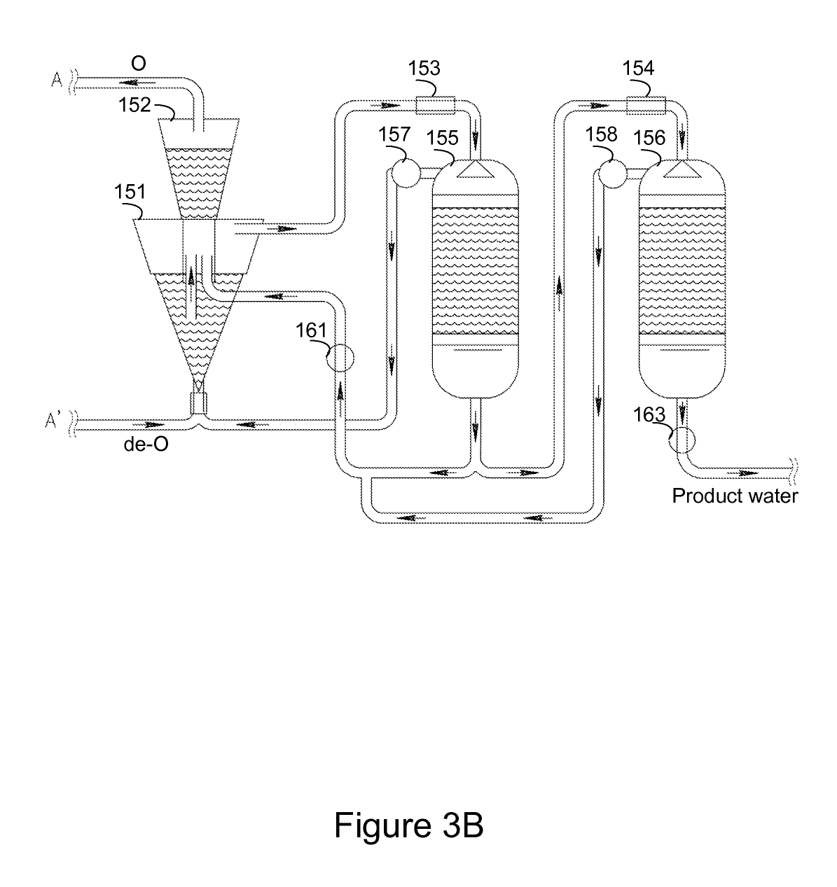

FIGS. 3A and 3B illustrate details of desalination system 101, according to some embodiments of the invention. The states of the draw solution in the pipes is designated as: G—high gauge pressure, de-G—low gauge pressure, O—high osmotic pressure, ½ O—intermediate osmotic pressure, de-O—low osmotic pressure, and Expanded ½ O, G—expanded (i.e. with increased throughput) draw solution at an intermediate osmotic pressure and high gauge pressure. Parameters relating to other fluids in the system are denoted by: G Feed—gauge pressurized feed water, G Brine—gauge pressurized brine, I. C. Feed—intermediately concentrated feed water.

An intake pump 111 pushes feed water, e.g. sea water, to power producing work exchanger 140, pressurized FO module 133 and high pressure pump 112. Most feed water is supplied to pressurized FO module 133 and to power producing work exchanger 140. For example, in the illustrated example, intake pump 111 may push 4 m³/sec to pressurized FO module 133 (for FO desalination) and 2 m³/sec to power producing work exchanger 140 (for RO desalination). High pressure pump 112 may increase the gauge pressure of feed water from 2-3 bars up to 70-83 bars. Feed water pumped directly to RO unit 110 via high pressure pump 112 may be of a marginal throughput (e.g. 0.02 m³/sec at 83 bar) selected to compensate for losses. The route via high pressure pump 112 may also be used for initialization of RO unit 110 and as reserve capability. Intake pump 111 may push feed water at a low pressure, e.g. 5 bar.

A circulation pump 113 may be used to compensate for pressure losses in RO unit 110, pressurized FO module 133, power producing work exchanger 140 and pipes. Circulation pump 113 may add 6 bar to a throughput of 2 m³/sec coming from power producing work exchanger 140.

Power producing work exchanger 140 and brine work exchanger 120 may be positive displacement devices, for example of DWEER (Dual Work Exchanger Energy Recovery) type, or ERI type (Energy Recovery Inc. PX energy recovery device that uses the principle of positive displacement and isobaric chambers) or any other pressure or energy exchange device which transfer pressure from one liquid to other liquid. DWEER includes two cylindrical modules with pistons hermetically separated different liquids. The device includes link valves and check valves that allow switching two cylindrical modules between a high pressure working cycle and a low pressure filling cycle. ERI includes a rotor in a bearing that alternately couples the high pressure input and output, and the low pressure input and output.

In the illustrated example, the 2 m³/sec entering RO unit 110 are used to generate 1 m³/sec product water and 1 m³/sec pressurized brine (e.g. at 70 bar), which is used to drive the 1 m³/sec draw solution through brine work exchanger 120 to pressurized FO membrane module 133. The expansion of the draw solution may be twofold to 2 m³/sec entering power producing work exchanger 140 and utilized to drive pressurized feed water to RO unit 110. The flow of 2 m³/sec through non-pressurized FO module 136 may result in 2 m³/sec brine and 3 m³/sec G- and O-depressurized dilute draw solution entering extraction unit 150.

In some embodiments, the draw solution is a solution of ammonia gas NH₃ and carbon dioxide gas CO₂ in water. The gases transform in solution to ammonium carbamate (NH₂COONH₄), ammonium bicarbonate (NH₄HCO₃) and ammonium carbonate ((NH₄)₂CO₃) Ammonium carbamate (NH₂COONH₄) results from the reaction CO₂+2NH₃→NH₂COONH₄, its solubility is about 423 gr/lit of water, starting to decompose at 35° C., and completely decomposes above 60° C. to NH₃ and CO₂. Ammonium bicarbonate (NH₄HCO₃) results from the reaction CO₂+NH₃+H₂O→NH₄HCO₃ its solubility is about 178 gr/lit of water, starting to decompose at 30° C., and completely decomposes above 60° C. to NH₃ and CO₂. Ammonium carbonate ((NH₄)₂CO₃) and ammonium carbamate (NH₂COONH₄) result from the reaction 2CO₂+4NH₃+H₂O→(NH₄)₂CO₃+NH₂COONH₄ at a large excess of NH₃.

In these embodiments, extraction unit 150 may comprise a crystallizer 151, resolvent chamber 152, a CO₂ desorber 155 with a heat exchanger 153 at the entrance and a vacuum pump 157 for exiting gaseous CO₂, a NH₃ desorber 156 with a heat exchanger 154 at the entrance and a vacuum pump 158 for exiting gaseous CO₂ and NH₃.

Crystallizer 151 is a conical tank for crystallizing ammonium carbamate, ammonium bicarbonate and ammonium carbonate. The tank may be constructed from stainless steel, glass-reinforced plastic, steel rubber covered etc. Resolvent chamber 152 is a smaller conical tank for dissolution of chemicals ammonium carbamate, ammonium bicarbonate and ammonium carbonate, that is connected to crystallizer 151. The materials of construction are similar to crystallizer 151.

CO₂ desorber 155 is a tower which filled with packing. The duty of the tower is to remove CO₂ from draw solution from crystallizer 151, that is heated by heat exchanger 153 (e.g. to 35° C., which together with the low pressure induces CO₂ release from the solution). Vacuum pump 157 pumps gaseous CO₂ from CO₂ desorber 155 to crystallizer 151.

NH₃ desorber 156 is a tower which filled with packing. The duty of the tower is to remove NH₃ and CO₂ residuals from the draw solution from CO₂ desorber 155, that is heated by heat exchanger 154 (e.g. to 60° C. for decomposing ammonium bicarbonate to NH₃ and CO₂ gases and water). Vacuum pump 158 pumps gaseous CO₂ and NH₃ from NH₃ desorber 156 to resolvent chamber 152.

Extraction unit 150 further comprises a product pump 163 for delivering product water from NH₃ desorber 156, a CO₂ desorber pump 161 (e.g. a centrifugal pump) for pumping draw solution from CO₂ desorber 155 to crystallizer 151.

The increased level of CO₂ in respect to NH₃ (e.g. NH₃/CO₂<1) resulting from the CO₂ input from CO₂ desorber 155, causes ammonium carbamate to transform to the less soluble ammonium bicarbonate Ammonium bicarbonate crystallizes because it reaches its solubility limit. The conical shape of crystallizer 151 slows down the solution with the increase of the diameter. The decrease in velocity causes the precipitated ammonium bicarbonate to float at a certain level in unit crystallizer 151. Above the layer of floating crystallized ammonium bicarbonate, the solution is saturated with dissolved ammonium bicarbonate, leaves crystallizer 151 and continues via heat exchanger 153 to CO₂ desorber 155. The crystallized ammonium bicarbonate particles are sucked into resolvent chamber 152.

Draw solution that reenters crystallizer 151 from CO₂ desorber pump 161 comprises a large proportion of NH₃ and causes the ammonium bicarbonate to transform in resolvent chamber 152 (e.g., at NH₃/CO₂ level exceeding 1.75) to the more soluble ammonium carbamate which thus completes the regeneration of the draw solution.

To summarize: crystallizer 151 is arranged to receive the G-de-pressurized draw solution of decreased osmotic pressure from FO unit 130 (e.g. non-pressurized membrane module 136) and a CO₂ rich gas from CO₂ desorber 155, to yield crystallized ammonium bicarbonate and an ammonium bicarbonate saturated solution thereabove in the conical tank. CO₂ desorber 155 is arranged to extract the CO₂ rich gas from the ammonium bicarbonate saturated solution, to yield a NH₃ rich solution. NH₃ desorber 156 is arranged to receive the NH₃ rich solution from CO₂ desorber 155 and to extract a NH₃ rich gas therefrom to yield the product water. Resolvent chamber 152 is arranged to receive a part of the NH₃ rich solution, the NH₃ rich gas and a part of the ammonium bicarbonate saturated solution, to yield the regenerated draw solution.

Extraction unit 150 finally comprises a resolvent chamber pump 159, e.g., a centrifugal pump, that is arranged to pump the re-concentrated draw solution from resolvent chamber 152 out of extraction unit 150 to brine work exchanger 120.

In some embodiments, the throughput into crystallizer 151 from non-pressurized FO module 136 may comprise 3 m³/sec of which 2.5 m³/sec is directed to CO₂ desorber 155 and 0.5 m³/sec is directed to resolvent chamber 152. Additional 0.5 m³/sec is directed to resolvent chamber 152 from the solution exiting CO₂ desorber 155 (enriched with gaseous NH₃ from NH₃ desorber 156) and the other 2 m³/sec are directed from CO₂ desorber 155 to NH₃ desorber 156 and are eventually turned into product water. The 1 m³/sec leaving resolvent chamber 152 is the regenerated draw solution.

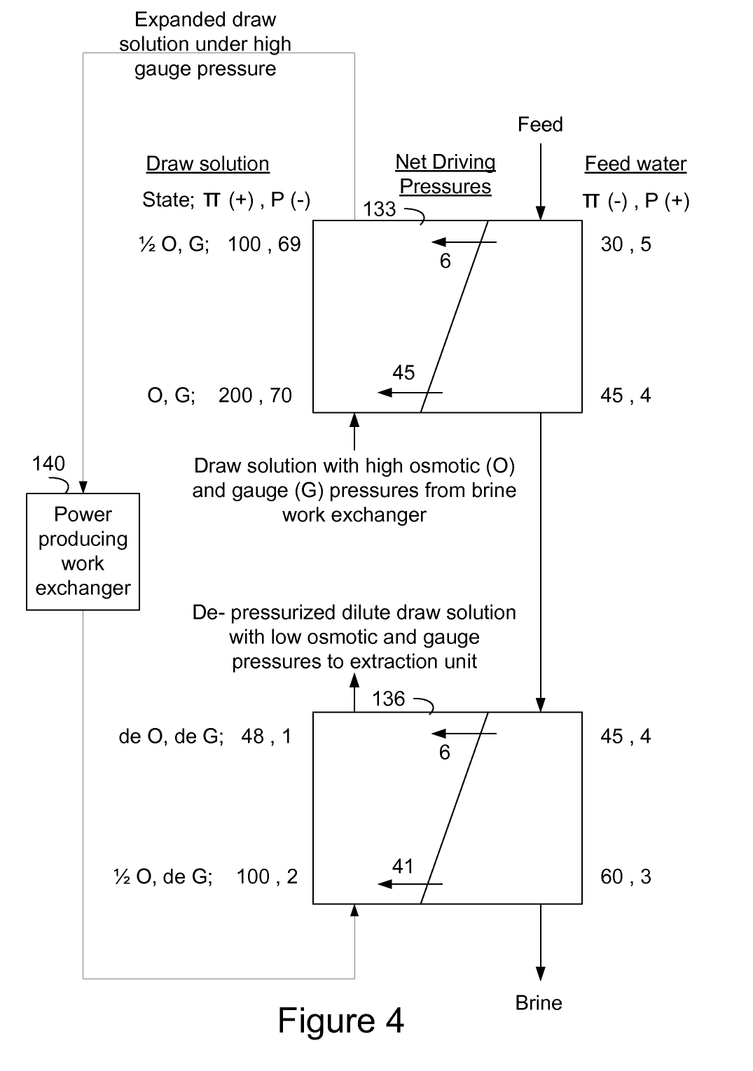

FIG. 4 illustrates a numerical example for pressures involved in the operation of FO unit 130, according to some embodiments of the invention. Exemplary pressures involved in the flow of feed water and draw solution through pressurized FO module 133 and non-pressurized FO module 136 are illustrated. At each module 133, 136, the net driving pressure is calculated, such as to illustrate the operation of the corresponding membranes. For the draw solution are presented: the state (G—high gauge pressure, de G—low gauge pressure, O—high osmotic pressure, ½ O—intermediate osmotic pressure, de O—low osmotic pressure) and examples for osmotic pressure (π) and gauge pressure (p) corresponding to each state. The values serve illustrative purposes only and are not to be taken as limiting the application of the disclosed invention. For the feed water examples for osmotic pressure (π) and gauge pressure (p) are presented. The pressure values are given for fluids entering and exiting each side of modules 133, 136. The net driving pressure resulting from these exemplary pressures is presented at each side of modules 133, 136 as a result of the calculation π (Draw)−p (Draw)−π (Feed)+p (Feed), as indicated by the signs in the diagram. Pressure values are in bars.

Pressurized FO module 133 and non-pressurized FO module 136 are illustrated such that feed water flow from top to bottom and exit non-pressurized FO module 136 as brine. The draw solution flows in the opposite direction to the feed water. The concentrated O- and G-pressurized draw solution (from brine work exchanger 120) flows through pressurized FO module 133 first, such that gauge pressure somewhat balances the high osmotic pressure and allows the operation of the membrane. In pressurized FO module 133 the draw solution expands due to water extracted from the feed water and its expansion against the gauge pressure is utilized to recover energy by power producing work exchanger 140.

The draw solution enters non-pressurized FO module 136 after exiting power producing work exchanger 140 in a low gauge pressure and an intermediate osmotic pressure (after extracting water from the feed water in pressurized FO module 133), and is utilized again to extract more water from the intermediately concentrated feed water exiting pressurized FO module 133. In non-pressurized FO module 136 the draw solution is diluted further, before being re-concentrated by extraction unit 150.

FIG. 4 thus illustrates that the combination of pressurized FO module 133 and non-pressurized FO module 136 allows a high level of water extraction from the feed water, together with the utilization of the expanded gauge pressurized draw solution for power generation.

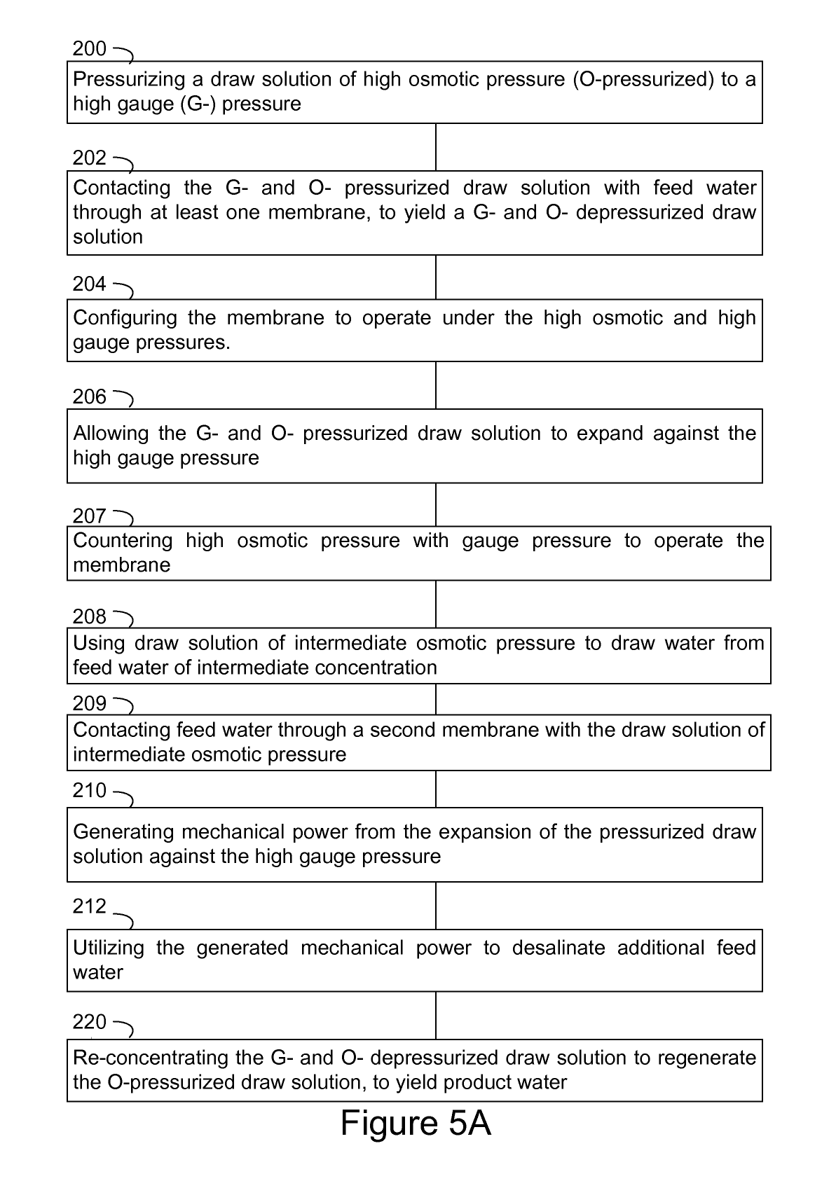

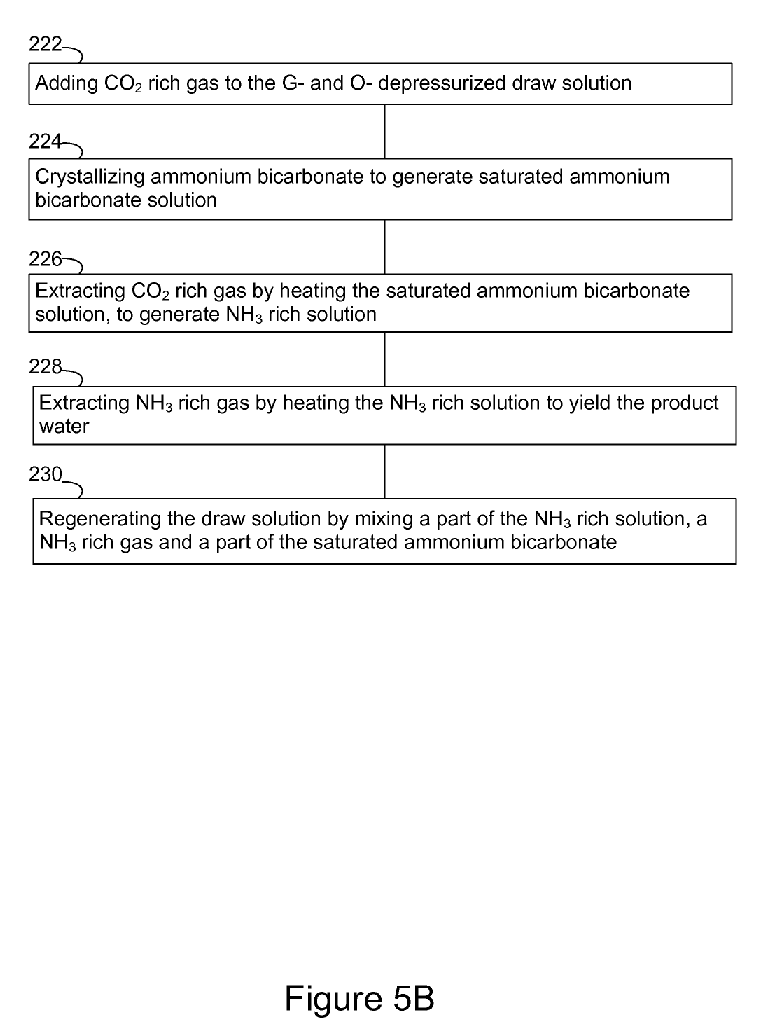

FIGS. 5A and 5B are schematic flowcharts illustrating a method of desalination and power recovery, according to some embodiments of the invention. The method comprises the following stages: Pressurizing a draw solution of high osmotic pressure (O-pressurized) to a high gauge (G-) pressure (stage 200); generating mechanical power (stage 210), by allowing the G- and O-pressurized draw solution to expand against the high gauge pressure (stage 206) upon contact with feed water through a membrane (stage 202), to yield a G- and O-depressurized draw solution; and re-concentrating the G- and O-depressurized draw solution (stage 220) to regenerate the O-pressurized draw solution, to yield product water.

The method may further comprise utilizing the generated mechanical power to desalinate additional feed water (stage 212), e.g. through a direct pressure exchange between the expanded G-pressurized draw solution and the additional feed water, such as via a reverse osmosis process.

The method may further comprise configuring the membrane to operate under the high osmotic and high gauge pressures (stage 204).

The method may further comprise sequentially contacting the G- and O-pressurized draw solution with the feed water through at least two membrane modules (stage 202), to exhaust the osmotic pressure of the draw solution for desalinating the feed water. The sequentially contacting (stage 202) may comprise: utilizing the gauge pressure to counter a high osmotic pressure of the draw solution such as to allow using the draw solution to draw a first water throughput from the feed water in through a first membrane (stage 207), to yield a draw solution of intermediate osmotic pressure and feed water of intermediate concentration; and drawing a second water throughput from the feed water of intermediate concentration (stage 208) by contacting it through a second membrane with the draw solution of intermediate osmotic pressure (stage 209), to yield O-de-pressurized dilute draw solution and concentrated brine. Re-concentrating the G- and O-depressurized draw solution (stage 220) thus yields substantially a sum of the first and second water throughput as product water. The draw solution of intermediate osmotic pressure may be used to draw water from other water feeds, such as sea or brackish water.

Re-concentrating the G- and O-depressurized draw solution to regenerate the O-pressurized draw solution and to yield product water (stage 220) may comprise the following stages, as illustrated in FIG. 5B: Crystallizing ammonium bicarbonate in a conical tank (stage 224), by adding CO₂ rich gas to the G- and O-depressurized draw solution (stage 222), to yield a saturated ammonium bicarbonate solution above the crystallized ammonium bicarbonate in the conical tank. The CO₂ rich gas may be extracted by heating the saturated ammonium bicarbonate solution, to yield a NH₃ rich solution (stage 226). Further—regenerating the draw solution by mixing a part of the NH₃ rich solution, a NH₃ rich gas and a part of the ammonium bicarbonate saturated solution (stage 230), wherein the NH₃ rich gas is extracted by heating the NH₃ rich solution to yield the product water (stage 228).

Advantageously, FO unit 100 operates at a very high osmotic pressure of the draw solution to achieve a very effective desalination of feed water by forward osmosis. The high osmotic pressure is countered by a high gauge pressure that is applied in order to enhance the functionality of the membrane and FO unit 100 as a whole in face of the high osmotic pressure.

The high gauge pressure is utilized to a further end, by using it to counter the expansion of the draw solution to transform the expansion to mechanical work. For example, in desalination system 101, the mechanical work is used directly to generate additional desalinated feed water through RO unit 110 at an essentially zero energy cost (except for some compensation for pressure losses).

FO unit 100 and desalination system 101 have the following decisive advantages over known FO systems for power generation that use the drawing pressure of sea water in respect to river water: (i) The use of high O- and G-pressures of the draw solution allows a higher energetic yield as well as a more effective use of feed water resulting in a smaller footprint. (ii) The use of a single source of feed water, enabled by using draw solution which is regenerated in a closed loop, relieves the need of having sea and river water sources in close proximity, and furthermore requires a single filtration system instead of two. (iii) The direct conversion of power to desalinated product water is both energy efficient and provides a solution to areas lacking potable water. In contrast, prior art power generating FO systems turns a large amount of non-saline river water to brackish water as byproduct of the process.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A desalination system comprising:
a forward osmosis (FO) unit, arranged to expand draw solution under high gauge (G-) and high osmotic (O-) pressures with water drawn from the feed water through a semi-permeable membrane, to yield an increase in a throughput and a decrease in the osmotic pressure of the draw solution;
a gauge pressure generating module arranged to introduce draw solution of high osmotic pressure into the FO unit at a high gauge pressure;
a power producing work exchanger arranged to receive the expanded draw solution from the FO unit and to generate mechanical power from the expansion of the draw solution against the high gauge pressure, to yield G-de-pressurized draw solution; and
an extraction module arranged to receive G-de-pressurized draw solution of decreased osmotic pressure and to the extract product water therefrom to re-concentrate the draw solution,
wherein the desalination system is arranged to simultaneously produce product water and mechanical power from forward osmosis at high osmotic and high gauge pressures.

2. The desalination system of claim 1, wherein the FO unit comprises:
a pressurized FO membrane module arranged to utilize the G- and O-pressurized draw solution to draw water from the feed water through a first membrane to produce the expanded G-pressurized draw solution and a intermediately concentrated feed; and
a non-pressurized FO membrane module arranged to utilize the de-pressurized draw solution to draw water from the intermediately concentrated feed through a second membrane to produce G- and O-de-pressurized draw solution,
wherein the power producing work exchanger receives the expanded G-pressurized draw solution from the pressurized FO membrane module and transfers the G-de-pressurized draw solution to the non-pressurized FO membrane,
wherein the intermediately concentrated feed is transferred from the pressurized FO membrane to the non-pressurized FO membrane for further extraction of product water, and
wherein the pressurized FO membrane module utilizes the high gauge pressure to counter the high osmotic pressure of the draw solution and thereby allow using the high osmotic pressure to effectively draw water from the feed water through the first membrane.

3. The desalination system of claim 2, wherein the membrane of the pressurized FO membrane module is arranged to operate under the high osmotic and high gauge pressures of the draw solution.

4. The desalination system of claim 1, wherein the draw solution comprises a solution of NH₃ and CO₂ in water, and wherein the extraction unit is arranged to draw NH₃ and CO₂ from the de-pressurized dilute draw solution to produce product water and regenerate a concentration of the draw solution.

5. The desalination system of claim 1, further comprising a reverse osmosis (RO) unit arranged to receive G-pressurized feed water and to produce product water and pressurized brine,
wherein the gauge pressure generating module comprises a brine work exchanger connecting the RO unit to the FO unit and arranged to receive the pressurized brine from the RO unit and to drive O-pressurized draw solution to the FO unit as G- and O-pressurized draw solution,
wherein the power producing work exchanger connects the FO unit to the RO unit and is arranged to receive the G-pressurized draw solution from the FO unit and utilize the increased throughput of the G-pressurized draw solution to drive feed water to the RO unit, thereby de-pressurizing the G-pressurized draw solution, and
wherein substantially all feed water throughput to the RO unit is supplied by the power producing work exchanger utilizing the increase in throughput of the G-pressurized draw solution.

6. The desalination system of claim 5, wherein the RO unit is arranged to produce pressurized brine at substantially half of a received feed water throughput, and wherein the increase in the G-pressurized draw solution throughput is substantially twofold.

7. The desalination system of claim 5, wherein the brine work exchanger and the power producing work exchanger utilize a positive displacement principle.

8. A method comprising:
pressurizing a draw solution of high osmotic pressure (O-pressurized) to a high gauge (G-) pressure;
generating mechanical power, by allowing the G- and O-pressurized draw solution to expand against the high gauge pressure upon contact with feed water through a membrane, to yield a G- and O-depressurized draw solution; and
re-concentrating the G- and O-depressurized draw solution to regenerate the O-pressurized draw solution and to yield product water.

9. The method of claim 8, further comprising utilizing the generated mechanical power to desalinate additional feed water.

10. The method of claim 9, wherein the utilization of the generated mechanical power is carried out through a direct pressure exchange between the expanded G-pressurized draw solution and the additional feed water.

11. The method of claim 10, wherein the desalination of additional feed water is carried out via a reverse osmosis process.

12. The method of claim 8, further comprising configuring the membrane to operate under the high osmotic and high gauge pressures.

13. The method of claim 8, further comprising sequentially contacting the G- and O-pressurized draw solution with the feed water through at least two membrane modules, to exhaust the osmotic pressure of the draw solution for desalinating the feed water.

14. The method of claim 13, wherein the sequentially contacting the G- and O-pressurized draw solution with the feed water comprises:
utilizing the gauge pressure to counter a high osmotic pressure of the draw solution such as to allow using the draw solution to draw a first water throughput from the feed water in through a first membrane, to yield a draw solution of intermediate osmotic pressure and feed water of intermediate concentration; and
drawing a second water throughput from the feed water of intermediate concentration by contacting it through a second membrane with the draw solution of intermediate osmotic pressure, to yield O-de-pressurized dilute draw solution and concentrated brine,
wherein the re-concentrating the G- and O-depressurized draw solution yields substantially a sum of the first and second water throughput as product water.
